(19) United States
(12) Patent Application Publication
(10) Pub. No.: US 2010/0016484 A1
(43) Pub. Date: Jan. 21, 2010

(54) PROCESS FOR PRODUCING 1,3,2-DIOXABORINANE COMPOUNDS

(75) Inventors: Karl Matos, Pittsburgh, PA (US); Alex J. Attlesey, Morristown, NJ (US); David F. Rouda, Renfrew, PA (US); Stefan Pichlmair, Pittsburgh, PA (US)

Correspondence Address: CONNOLLY BOVE LODGE & HUTZ, LLP, P O BOX 2207, WILMINGTON, DE, 19899, US

(73) Assignee: BASF SE, Ludwigshafen (DE)

(21) Appl. No.: 12/175,868

(22) Filed: Jul. 18, 2008

(51) Int. Cl. C07F 5/02; C08K 5/55

(52) U.S. Cl. 524/108; 568/6

(57) ABSTRACT

A process for producing a 1,3,2-dioxaborinane compound of the general formula (I)

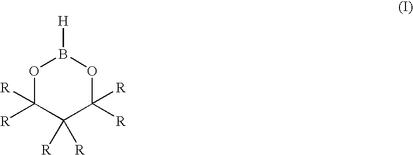

in which each R individually is selected from the group consisting of H and C₁₋₈-alkyl, by reacting a diol of the general formula (II)

HO—CRR—CRR—CRR—OH (II)
with diborane is performed without using a solvent.

### FIELD OF THE INVENTION

The present invention relates to a new process for producing 1,3,2-dioxaborinane compounds.

### BACKGROUND OF THE INVENTION

The direct borylation of aromatic halides with pinacolborane is a growing business for pharmaceutical applications. The use of low cost diols such as 2-methyl-2,4-pentanediol and 2,2-dimethyl-1,3-propanediol will enable expansion of the direct borylation applications to agrochemical processes. There is a need for lower cost borane derivatives of diols for the preparation of active agents in the pharma and agrochemicals sectors.

The synthesis of 4,4,6-trimethyl-1,3,2-dioxaborinane (HexB) was first reported by Woods et al. (Woods, W. G.; Strong, P. L., J. Am. Chem. Soc. 1966, 88, 4667; U.S. Pat. No. 3,383,401 and U.S. Pat. No. 3,064,032) and involves a process for the formation of HexB with sodiumborohydride and the corresponding 2-chloro-4,4,6-trimethyl-1,3,2-dioxaborinane. Furthermore, a low yielding synthesis of HexB from diborane in diethyl ether was reported.

Murata et al. (Murata, M.; Takeshi, O.; Watanabe, S.; Masuda, Y. Synthesis, 2007, 3, 351) recently reported the synthesis of 4,4,6-trimethyl-1,3,2-dioxaborinane from di-methylsulfide borane (DMSB) and hexylene glycol. The synthesis results in HexB that contains traces of dimethylsulfide (DMS) and has a strong malodour.

Alternatively Chavant et al. (Praveen Ganesh, N.: d'Hondt, S.; Yves Chavant P.) report a procedure for the formation of diborane from iodine/NaBH₄, in diglyme, followed by subsequently reacting it with a solution of hexylene glycol in toluene or dicloromethane, see J. Org. Chem. 2007, 72, 4510-4514.

RU-A-2 265 023 relates to a method of obtaining pinacolborane. 4,4,5,5-tetramethyl-1,3,2-dioxaborolane (pinacolborane) is obtained by reacting pinacol with diborane typically in the presence of diethylether as a solvent at a temperature in the range of from 5 to 36° C. Pinacol and diborane are used in a molar ratio in the range of 1:0.45 to 0.55.

HexB is a commercially available reagent that has the following advantages over other reagents:
high stability compared to other borane reagents due to stabilizing compounds formed during the process
no pressure built up during DOT testing at 55° C. for six weeks in the presence of the stabilizing compounds.
shipping is possible without decomposition
no refrigerated shipping is required if sufficiently stabilized
No additional stabilizer or additives are required beyond the process byproducts which act as stabilizers
depending on the optimization of the preparation process, no distillation is required

### SUMMARY OF THE INVENTION

The object of the present invention is to provide a new process for producing a 1,3,2-dioxaborinane compound which does not contain traces of dimethylsulfide (DMS) and is stench free and stable upon storage without requiring additional stabilizers or additives. Furthermore, the HexB obtained from the process should preferably be of a purity level that does not need any laborious workup or purification.

The object is achieved by a process for producing a 1,3,2-dioxaborinane compound of the general formula (I)

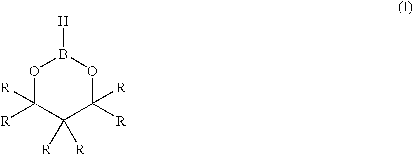

in which each R individually is selected from the group consisting of H and C₁₋₆-alkyl, by reacting a diol of the general formula (II)

HO—CRR—CRR—CRR—OH (II)

with diborane without using a solvent.

The residues R can be the same of different from each other.

According to one embodiment of the invention, dimethylether can be employed as a solvent.

According to the present invention it has been found that diols of the general formula (II) can be reacted with diborane without using a solvent, especially when the diborane is added to the diol or both are simultaneously and/or continuously fed to a reactor. The inventors found that in the above process without using a solvent HexB can be obtained which contains only stabilizing amounts of B(OR)₃ and consequently does not require a distillation. Typically, a product with a B(OR)₃ content as low as 0 or 0.01 to 10% by weight can be obtained. The process according to the present invention leads to HexB that is free from DMS, solvent and excessive amounts of borate. The product is stable upon storage at 55° C. for six weeks depending on the degree of stabilization. Therefore, no additives like DMS is necessary to stabilize the product.

The invention allows for the preparation and use of DMS-free borylation reagents. DMSB-based dioxaborinanes always require borane-complexes for synthesis and often contain DMS. The product is essentially or totally solvent free so that no solvent or DMS-by-product removal is necessary.

According to the present invention it has been found that compounds of the general formula B(OR′)₃ stabilize 1,3,2-dioxaborinane compounds, especially the compounds listed below.

Thus, the invention also relates to a method of stabilizing 1,3,2-dioxaborinane compounds involving the step of contacting the 1,3,2-dioxaborinane compound with a compound of the general formula (III) or oligomers thereof

B(OR′)₃ (III)
with
R′ independently OH, C₁₋₁₂-alkyl, C₂₋₁₂-hydroxyalkyl
or where two R′ together form an C₃₋₂₄-alkylene group, to link together the oxygen bonded to the boron.

The compounds of the general formula (III) can be added to the final 1,3,2-dioxaborinane compounds after their preparation. Preferably, the compounds of the general formula (III) are formed in the process for producing the 1,3,2-dioxaborinane compounds.

### DETAILED DESCRIPTION OF THE INVENTION

The process of the present invention preferably leads to 1,32-dioxaborinane compounds of the formula (I) wherein from 2 to 4 residues, R groups, on the carbon atoms adjacent to the oxygen independently are C₁₋₃-alkyl, especially C₁₋₂-alkyl, specifically methyl and the other R groups are hydrogen.

More preferably, the compound of the general formula (I) is 4,4,6-trimethyl-1,3,2-dioxaborinane.

The process according to the present invention can be carried out at a wide range of temperatures. Preferably, the process is carried out at a temperature in the range of from −30 to 120° C., especially −10 to 50° C., preferably −5 to 30° C.

The reaction can be carried out in a wide range of pressures. Preferably, the pressure is in the range of 0.01 to 12 bar, more preferably 0.5 to 10 bar, especially 0.7 to 7 bar, preferably 1.4 to 3.6 bar.

Diborane and the diol of the general formula (II) can be employed in a wide range of proportions. Typically, the amount of diborane should be at least equimolar to the amount of diol. According to a preferred embodiment of the invention, an excess of 1 to 50 mol %, especially 5 to 30 mol % of diborane is employed with regard to the diol, and the reaction mixture is warmed to at least room temperature after the initial reaction. This leads to an equilibration from diboronated B₂Hex₃ to HexB and results in a product with a low B(OR)₃ content. Since diborane is an expensive compound, the excess of diborane should be as low as possible to give HexB with the desired amount of stabilizing B(OR)₃ content. An optimized process may be performed with an excess of 5 mol % of diborane or less.

The product obtained by the process of the present invention can be directly used as a borylation reagent, thus requiring no further purification like distillation. Optionally, a distillation can be carried out. When the process using an excess of diborane is performed, the product obtained is preferably freed from excess diborane by sparging with an inert gas, especially by sparging with nitrogen or argon.

The process according to the present invention can be carried out continuously or as a batch process. Preferably, the process is carried out as a batch process wherein the diborane is added to the diol.

In the process according to the present invention, preferably a stabilizing amount of compounds of the general formula (III) or oligomers thereof

B(OR′)₃ (III)
with R′ independently OH, C₁₋₁₂-alkyl, C₂₋₁₂-hydroxyalklyl
   or where two R′ together form an C₃₋₂₄-alkylene group,

R′ is preferably C₁₋₆-alkyl, C₂₋₆-hydroxyalkyl, or two R′ together form a C₅₋₁₈-alkyl group, is formed in the process.

Preferably, in the compound of the general formula (III), the residues R′ are derived from the diol of the general formula (II). In this case, the compound of the general formula (III) can be B(Hex)₃ or B₂(Hex)₃ as well as longer oligomers thereof, corresponding to Bₙ(Hex)ₘ. n and m can individually be 1,2,3 etc.

According to the present invention it has been found that the compounds of the general formula (III) help to stabilize the 1,3,2-dioxaborinane compounds of the general formula (I). The compounds of the general formula (III) may be added in the course or at the end of the process, or they are formed during the process from the reactants present in the reaction system. After completion of the reaction the stabilizing amounts of the compounds of the formula (III) need not be separated from the product so that they can stabilize the product. Preferably, the stabilizing amount is at a level that the 1,3,2-dioxaborinane compound, preferably 4,4,6-trimethyl-1,3,2-dioxaborinane (HexB) fulfills the department of transportation test (DOT test). By including the compounds of the general formula (III), the 1,3,2-dioxaborinane compounds fulfill this requirement. They preferably have a purity in the range of from 90 to 99.9%, more preferably 97 to 99%. To show the stabilizing effect of the compounds of the general formula (III), B₂(Hex)₃ was synthesized and added to a HexB composition. It was found that the compound shows a stabilizing effect.

Furthermore, according to the invention it was found that amines show a stabilizing effect. Therefore, according to one embodiment of the invention, after the completion of the reaction at least one amine can be added to stabilize the compound of the general formula (I). Preferably, the amine is a trialkylamine, most preferably triethylamine. Especially triethylamine has a dramatic stabilizing effect and levels as low as 0.1 to 1% by weight, more preferably 0.3 to 0.7% by weight, are sufficient for passing the DOT test.

The amine is preferably added at the end of the preparation process, whereas the compounds of the general formula (III) can be added or formed during the process.

The process according to the present invention is preferably carried out in a semi-batch feed mode. In this process the diol of the general formula (II) is simultaneously fed together with diborane to a reactor. By adding diborane simultaneously to hexylene glycol or the diol of the general formula (II), a product decomposition can be avoided in case of interruption of diborane-feed or a production shutdown. Diborane should be present in the reactor as long as the diol is present. Therefore, a simultaneous feed of the two reactants is a much more robust process compared to an ordinary batch process. Therefore, the process is preferably carried out in the semi-batch feed-mode.

In a further preferred embodiment, an amount of the compound of the general formula (I) is present as a heel material in the reactor at the beginning of the process to act as a heat sink and to allow an agitation of the reaction mixture. Thus, first an amount of heel material is produced or introduced into the reactor. Subsequently, the co-feed of diborane and diol into the reactor is started. After completion of the reaction, the reactor can be emptied and the product may be used or introduced into a work-up process.

The semi-batch feed-mode delivers compounds of general formula (I) in the desired purity without decomposition of the final product, and only low amounts of compounds of the general formula (III) are formed. Their amount is sufficient for stabilizing the reaction product. The co-feed mode has the advantage that by feeding for example 20% of diborane ahead of diol, it is possible to stop feeding the process at any time without purity decrease. The most preferred process is a semi-batch feed process to prepare a heel material (minimum amount), followed by a co-feed mode.

The compound of the general formula (I) may be purified after the completion of the production by distillation. Preferably, a wiped film evaporator is used for the distillation since the residence time at high temperature is very low.

It is also possible to carry out the process according to the present invention in the presence of dimethylether as solvent. However, the solvent has to be removed after the process, so this process variant is less preferred.

Optionally, an amine can be added to the product in order to stabilize it. Preferably, the amount of added amine is in the range from 0.0001 to 5% by weight, based on the compound of the general formula (I).

The product obtained according to the present invention is stable upon storage without adding DMS. The storage stability is measured at 55° C. for six weeks.

The product obtained according to the present invention contains preferably as low amounts of B(OR)₃ as possible. The content of B(OR)₃ can be in the range of from 0 to 15 mol %, often 0.5 to 4 mol %, especially 0.5 to 3 mol %. The product does not contain any solvent impurities like ether solvents, aliphatic and aromatic hydrocarbons, chlorinated solvents, esters or impurities such as dimethylsulfide, amines, nitrites and carboxylic acids. Amines may, however, be added as stabilizers.

Those skilled in the art will appreciate that the invention described herein is subject to variations and modifications other than those specifically described herein. It is to be understood that the invention includes all such variations and modifications. The invention also includes all of the steps, features, compounds and compositions referred to or indicated in this specification, individually or collectively, and any and all combinations of any two or more of said steps or features.

While the present invention is described herein with the reference to illustrated embodiments, it should be understood that the invention is not limited to these examples. Therefore, the present invention is limited by the claims attached herein.

The invention is further illustrated by the following examples:

### EXAMPLES

### Example 1

The process is a two step procedure where A.) a minimal amount of hexylene glycol borane as heel material is produced and B.) a large volume of product is produced in co-feed mode.

Step A: Hexylene glycol borane is prepared as heel material by an uninterrupted semi-batch diborane feed into hexylene glycol using 20-50 psi (1.39-3.45 bar) backpressure and temperatures between 0 and 20° C. Once the diborane feed is completed, a minimum amount of heel material is present which serves as heat sink for a subsequent co-feed mode and as minimum liquid level to ensure that agitation is possible in the reactor. The heel forming step can be avoided by charging hexyleneglycol borane of past production lots to the reactor in order to immediately continue with step B (preferred operation).

Step B: The process is continued by continued feed mode (co-feed) by simultaneously adding gaseous diborane and hexylene glycol. Diborane excess is added in such way to ensure high levels of purity of the final product. Depending on the efficiency of the process setup 0-20% diborane excess might be required. No excess of diborane is preferred.

After completion of the feed, a digestion time of 1 hour in the cold and 1 hour at 15-30° C. is recommended to ensure high purity of the product. Any excess of diborane is removed by sparging with inert gas and venting it to a scrubber system. The product can be discharged into drums or holding tanks.

### Example 2

2-Methyl-2,4-pentanediol (118.2 g, 1.00 mole) was charged into a reactor (1 L) equipped with a dip-tube, thermocouple and attached to the diborane feed system (back pressure 30 psig). The diol was cooled to 020 C. and diborane (33.19 g, 1.20 mole, 1.2 eq.) was added in such a way that the temperature was maintained at 0-5° C. and a diborane flow rate of 10 g/h. When the diborane feed was completed after 3.5 hours, the temperature was kept at 0° C. for another 2 hours, then the mixture was allowed to warm to room temperature and continued stirring at r.t. for 2 hours. The backpressure was released and excess diborane was removed by sparging the reactor with nitrogen (0.75 hours). The reactor was emptied into a dry, nitrogen-flushed cylinder. The product was analyzed accordingly. The product was found to be 97.7% pure by ¹¹B NMR.

### Example 3

a.) Distillation at 35° C./12 torr of 73.53 g (95% pure HexB from reaction) gave 57 g (99.8%) of pure product along with 16.46 g (22.1%) of waste material (material containing borates and some).
b.) A second distillation was done on a larger ˜500 g scale. The maximum pot temperature was 85-90° C. resulting in 79% product recovery (100% pure by B NMR) and 21% product loss.

### Example 4

The semi-batch protocol from Exp. 2 was repeated on a 0.5 mol scale at 25-30° C. using 20% excess diborane to result in 97.4% pure hexyleneglycol borane.

### Example 5

The semi-batch protocol from Exp. 2 was repeated on a 2 mol scale at 0° C. using a 4 h feed time and using only 5% diborane in excess resulting in 97.5% pure hexyleneglycol borane.

### Example 6

The semi-batch protocol from above was repeated on 3.5 mole scale using 20% excess diborane at 10° C. and a total feed time of 14 hour to result in material with 96.5% pure hexyleneglycol borane.

### Example 7

HexB was prepared in semi-batch mode by feeding diborane to hexylene glycol resulting in 256.2 g (2.00 mole) of HexB (97.5% pure) which served as heel material. Meanwhile, hexylene glycol 236.2 g (2.00 mole) was charged into a Fisher Porter bottle, which was calibrated in such a way that the amount hexylene glycol added to the reactor can be monitored. The Fisher Porter bottle was connected to a dip-leg into the reactor. The reactor was pressurized to 40 psig N₂. Then diborane was fed into the system. As soon as the theoretical amount of diborane (1 equ. “BH₃”) was added for completion of the continuous diborane feed, the hexylene glycol feed was started and diborane feed was continued until additional 2 moles of hexylene glycol (256.2 g) were added (4 moles of hexylene glycol in total in the reactor) and a total amount of diborane (68 g, 4.92 mol, 1.22 equ.) was added. Temperature was maintained at less than 15° C. Once 2 moles of hexylene glycol and diborane were added (thus 4 modes in total), the diborane feed was continued until an excess of 22% was reached. Stirring was continued for 2 hours while warming to room temperature, followed by another 2 hours at room temperature. The backpressure was released and excess diborane was sparged with nitrogen (0.75 hours). The reactor was emptied into a dry, nitrogen-flushed cylinder.

The material so obtained was 97.5% pure (2.5% borates) according to ¹¹B NMR.

### Example 8

after completion of a batch of hexylene glycol borane, triethylamine (TEA) was added to the batch to stabilize HexB. To obtain 1 w % triethylamine in HexB, hexylene glycol borane (512.4 g, 2 mole) was stirred in a reactor with 5.12 g of triethylamine at ambient temperature for 30 minutes. The final product was discharged into a cylinder.

### Example 9

### Semibatch Diborane Feed Into Dimethylether

Hexylene glycol (238.8 g, 2.02 mole) was charged to a glass pressure reactor and cooled to 0° C. 239 g of dimethylether (DME) was charged to the reaction and the pressure rose to 40 psig. The mixture was stirred to result in a homogeneous mixture and the temperature was stable at 0° C. Diborane (32 g, 2.31 mole, 1.14 eq.) was fed to the reactor over a period of 3.25 hours while allowing the temperature to warm up to 12.1° C. After completion of the feed, cooling was turned off and the reactor content was allowed to warm to room temperature within 3.25 hours. The reactor was vented to release all volatile dimethylether. The reaction mixture was purged with nitrogen for 3 hours. The final product resulted in hexylene glycol borane with a purity of 95.9% by ¹¹B NMR.

### Example 10

Mixtures of HexB with stabilizers were tested for decomposition on-set temperature and energy using DSC analysis (differential scanning calorimetry). A distinct correlation between borate content in the sample and on-set temperature was observed. Addition of B(OR′)₃ type compounds increased the decomposition on-set temperature to higher values demonstrating proof that the mixtures showed increased thermal stability.

| | HexB Sample | | |
|---|---|---|---|
| Entry | (Additive or % Purity) | On-set. [° C.] | Energy [J/g] |
| 1 | 1 w % TEA | 179.0 | −288.5 |
| 2 | 0.5 w % TEA | 185.0 | −364.2 |
| 3 | 0.1 w % TEA | 225.0 | −358.2 |
| 4 | 1.5 w % DME + 1 w % | 257.0 | −254.7 |
| | TEA | | |
| 5 | distilled, 100% | 159.0 | −310.5 |
| 6 | 98.7% pure (11B NMR) | 248.0 | −451.9 |
| 7 | 97.5% pure (11B NMR) | 210 | −438.7 |
| 8 | 92% pure (11B NMR) | (>350) | N.A. |
| 9 | 1 w % DMS | 169.0 | −412.2 |
| 10 | 1 w % (B₂Hex₃) | 203.0 | −414.5 |
| 11 | 5 w % (B₂Hex₃) | 298 | −480.3 |
| 12 | 5 w % Et₂O | 172 | −411.5 |

There is a correlation in on-set temperature of the mixture and the content of B(OR′)₃ type compounds. The higher the amount of B(OR′)₃ type compounds, the higher the on-set temperature. Upper temperature detection limit is 350° C. No decomposition onset peak detectable in example 8.

DOT tests with 2.3 wt % B₂Hex₃ resulted in a pressure of 50 psi after 15 days. Samples containing 1 wt %, 2.3 wt % and 5 wt %, respectively, of B₂Hex₃, passed the DOT test, whereas samples containing 1 wt % DMS or 0.1 wt % TEA failed.

1. Process for producing a 1,3,2-dioxaborinane compound of the general formula (I) 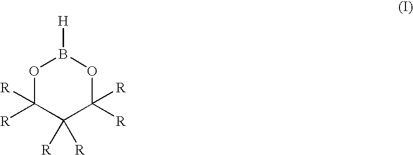
in which each R individually is selected from the group consisting of H and C₁₋₆-alkyl, by reacting a diol of the general formula (II)
HO—CRR—CRR—CRR—OH (II)
with diborane without using a solvent.

2. Process as claimed in claim 1 wherein in the compound of the general formula (I) 2 to 4 residues R on the carbon atoms adjacent to the oxygen independently are C₁₋₃-alkyl and the other R are hydrogen.

3. Process as claimed in claim 2, wherein the compound of the general formula (I) is 4,4,6-trimethyl-1,3,2-dioxaborinane.

4. Process as claimed in claim 1, wherein the process is carried out at a temperature in the range of from −40 to 50° C.

5. Process as claimed in claim 1, wherein the process is carried out at a pressure in the range of from 0.5 to 10 bar.

6. Process as claimed in claim 1, wherein an excess of 1 to 50 mol-% of diborane is employed with regard to the diol, and wherein the reaction mixture is warmed to at least room temperature after the initial reaction.

7. Process as claimed in claim 1, wherein the product obtained is freed from excess diborane by sparging with inert gas.

8. Process according to claim 1 where diborane is added without interruptions to the reactor or where diborane is added either in semi-batch mode to hexylene glycol or in continuous feed mode to hexyleneglycol borane.

9. Process as claimed in claim 1, wherein a stabilizing amount of compounds of the general formula (III) or oligomers thereof
B(OR′)₃ (III)
with R′ independently OH, C₁₋₁₂-alkyl, C₂₋₁₂-hydroxyalkyl
or where two R′ together form an C₃₋₂₄-alkyle group,
is produced during the process or added during or at the end of the process.

10. Process as claimed in claim 9, wherein in the compound of the general formula (III), the residues R′ are derived from the diol of the general formula (II).

11. Process as claimed in claim 1, wherein after the completion of the reaction, at least one amine is added to stabilize the compound of the general formula (I).

12. Process as claimed in claim 11, wherein the amine is a trialkylamine.

13. Process as claimed in claim 1, wherein the process is carried out by simultaneously feeding of diborane and the diol of the general formula (II) to a reactor.

14. Process as claimed in claim 13, wherein an amount of the compound of the general formula (I) is present as a heel material in the reactor at the beginning of the process to act as a heat sink and to allow an agitation of the reaction mixture.

15. Process as claimed in claim 1, wherein the compound of the general formula (I) is purified by distillation.

16. Process as claimed in claim 15, wherein a wiped film evaporator is used for the distillation.

17. Process for producing a 1,3,2-dioxaborinane compound of the general formula (I) 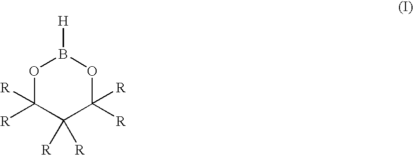
in which each R individually is selected from the group consisting of H and C₁₋₆-alkyl, by reacting a diol of the general formula (II)
HO—CRR—CRR—CRR—OH (II)
with diborane, wherein the reaction is carried out in the presence of dimethylether as solvent.

18. A method of stabilizing 1,3,2-dioxaborinane compounds involving the step of contacting the 1,3,2-dioxaborinane compound with a compound of the general formula (III) or oligomers thereof
B(OR′)₃ (III)
with
R′ independently OH, C₁₋₁₂-alkyl, C₂₋₁₂-hydroxyalkyl
or where two R′ together form an C₃₋₂₄-alkylene group.

19. A method as claimed in claim 18, where 0.01-10% of stabilizing agents is used.
